(19) United States
(12) Patent Application Publication
(10) Pub. No.: US 2026/0142140 A1
(43) Pub. Date: May 21, 2026

(54) ELECTRODE PLATE AND MANUFACTURING METHOD THEREOF

(71) Applicant: SAMSUNG SDI CO., LTD., Yongin-si (KR)

(72) Inventor: Hyunjin LEE, Yongin-si (KR)

(21) Appl. No.: 19/312,808

(22) Filed: Aug. 28, 2025

(30) Foreign Application Priority Data
Nov. 21, 2024 (KR) 10-2024-0167621

(51) Int. Cl. H01M 4/04; H01M 4/02; H01M 4/36; H01M 4/505; H01M 4/525; H01M 4/58; H01M 4/587; H01M 10/0525

(52) U.S. Cl. CPC H01M 4/0416; H01M 4/366; H01M 4/505; H01M 4/525; H01M 4/5825; H01M 4/587; H01M 10/0525; H01M 2004/021; H01M 2004/027; H01M 2004/028

(57) ABSTRACT

A manufacturing method of an electrode plate of a rechargeable battery includes mixing a slurry while leaving bubbles in the slurry, coating the slurry containing the bubbles on a substrate, magnetizing the slurry coated on the substrate, and generating an active material layer on the substrate by drying the slurry.

### CROSS-REFERENCE TO RELATED APPLICATION

This application claims priority to and the benefit of Korean Patent Application No. 10-2024-0167621 filed with the Korean Intellectual Property Office on Nov. 21, 2024, the entire contents of which is incorporated herein by reference.

### BACKGROUND

### 1 Field

The present disclosure relates to an electrode plate and a manufacturing method thereof.

### 2. Description of the Related Art

Recently, rechargeable batteries have been widely applied not only to small devices such as portable electronic devices, but also to medium-to-large devices such as battery packs of hybrid vehicles or electric vehicles or power storage devices.

Such a rechargeable battery is a power generating device formed in a stack structure of positive electrode-separator-negative electrode and capable of being repeatedly charged and discharged, in which, generally, the positive electrode includes lithium metal oxide as a positive active material, and the negative electrode may include carbon negative active material such as graphite. Lithium ions emitted from the positive electrode during charging are intercalated into the carbon negative active material of the negative electrode, and during discharge, lithium ions contained in the carbon negative active material are intercalated into the lithium metal oxide of the positive electrode, such that charging and discharging may be repeated.

At this time, a graphite material such as natural graphite may be an example of the negative active material used in the negative electrode. This kind of graphite has a layered structure, and carbon atoms form a mesh structure such that it may be formed as a stack of a plurality of planarly spread layers.

During charging, lithium ions invade the edge surface of these graphite layers (the surface where the layers overlap) and diffuse between layers. Additionally, during discharge, lithium ions may desorb and be released from the edge of the layer. In addition, since the electrical resistivity of graphite in the plane direction of the layer is lower than that in the stacking direction of the layers, a conduction path for electrons detouring along the plane direction of the layer is created.

In this regard, the process of manufacturing the electrode plate of a lithium rechargeable battery using graphite may include discharging a slurry onto a substrate, magnetizing the graphite by orienting the graphite to a magnetic field, and a drying the slurry.

Here, orienting the graphite contained in the negative electrode to a magnetic field may be performed in order to improve the charging performance of the negative electrode. More specifically, when forming the negative electrode, the [0,0,2] crystal plane of graphite is oriented in a magnetic field so that it is almost horizontal with respect to the negative electrode current collector, and this is fixed. Since the edge surface of the graphite layer faces the positive electrode active layer, the intercalation and deintercalation of lithium ions are performed smoothly, and at the same time, the electronic conduction path is shortened, thereby improving the electronic conductivity of the negative electrode, and thereby improving the charging performance of the battery.

A method of aligning the graphite by applying a magnetic field to the negative electrode slurry containing graphite as a carbon negative electrode active material using a magnetizing device is applied when manufacturing the negative electrode. In more detail, orientation refers to the process of making the direction of the graphite layer constant by passing the negative electrode coating layer over a magnetizing device containing a powerful permanent magnet. If the orientation is good, the movement distance of lithium (Li) ions within the graphite is minimized, reducing resistance to movement and improving battery performance.

### SUMMARY

A manufacturing method of an electrode plate may include a mixing step for mixing a slurry while leaving bubbles in the slurry, a coating step for coating the slurry containing the bubbles on a substrate, a magnetizing step for magnetizing the slurry coated on the substrate, and a drying step for generating an active material layer on the substrate by drying the slurry.

A negative electrode solid concentration of the slurry mixed in the mixing step may be in a range of 50 to 60 wt %, and a density of the slurry may be in a range of 1.1 g/cc to 1.3 g/cc.

A positive electrode solid concentration of the slurry mixed in the mixing step may be in a range of 70 to 80 wt %, and a density of the slurry may be in a range of 2.0 g/cc to 2.36 g/cc.

The active material layer may include a first active material layer and a second active material layer, and the coating step may be configured to, with a coating device including a first slot and a second slot, simultaneously coat a first slurry used for generating the first active material layer and a second slurry used for generating the second active material layer, on the substrate.

The second slurry may be coated on the first slurry.

The active material layer may include a first active material layer and a second active material layer, and the coating step may be configured to, with a coating device including a first slot and a second slot, coat a first slurry used for generating the first active material layer and then, coat a second slurry used for generating the second active material layer, on the first slurry.

The mixing step may generate the slurry by mixing a graphite particle, a binder, a conductive material and a solvent.

The active material layer may include a positive electrode active material.

The positive electrode active material may be one of a lithium manganese oxide, lithium nickel oxide, lithium cobalt oxide, lithium nickel manganese oxide, lithium nickel cobalt manganese oxide, lithium nickel cobalt aluminum oxide, lithium iron phosphate compound, lithium manganese phosphate compound, lithium cobalt phosphate compound, and lithium vanadium phosphate compound.

The active material layer may include a negative electrode active material.

The negative electrode active material may be a material allowing intercalation and deintercalation of lithium ions, and the negative electrode active material may be one of a carbon material such as crystalline carbon, amorphous carbon, carbon composite, and carbon fibers, a lithium alloy, silicon (Si), and tin (Sn).

An internal resistance of the electrode plate may be in a range of 1.00 mΩ to 1.20 mΩ.

### BRIEF DESCRIPTION OF THE DRAWINGS

Features will become apparent to those of skill in the art by describing in detail exemplary embodiments with reference to the attached drawings in which:

FIG. 1 is an exploded perspective view showing a rechargeable battery, according to an embodiment.

FIG. 2 is a cross-sectional view showing an electrode plate included in the rechargeable battery of FIG. 1.

FIG. 3 is a flowchart showing a manufacturing method of an electrode plate according to an embodiment.

FIG. 4 is a cross-sectional view showing a process of coating a first slurry and a second slurry on a substrate by a coating device.

FIG. 5 is a cross-sectional view sequentially showing a process in which a slurry is dried by a drying device.

FIG. 6 schematically illustrates a substrate and an active material layer of an electrode plate according to Comparative Example 1.

FIG. 7 schematically illustrates a substrate and an active material layer of an electrode plate according to Comparative Example 2.

FIG. 8 schematically illustrates a substrate and an active material layer of an electrode plate according to Comparative Example 3.

FIG. 9 schematically illustrates a substrate and an active material layer of an electrode plate manufactured by a manufacturing method of an electrode plate according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, the term “and/or” includes any one and all combinations of one or more of the associated listed items. In addition, it should be understood that when an element A is referred to as being “connected to” an element B, the element A can be directly connected to the element B, or an intervening element C may be present therebetween such that the element A and the element B are indirectly connected to each other.

The terminology used herein is for the purpose of describing particular embodiments only and is not intended to be limiting of the disclosure. As used herein, the singular forms are intended to include the plural forms as well, unless the context clearly indicates otherwise. It will be further understood that the terms “comprise,” “include,” “comprising,” and/or “including,” when used in this specification, specify the presence of stated features, numbers, steps, operations, elements, and/or components, but do not preclude the presence or addition of one or more other features, numbers, steps, operations, elements, components, and/or groups thereof.

It should be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present disclosure.

In addition, terms related to a space, such as “beneath”, “below”, “lower”, “above”, “upper”, or the like, may be used for better understanding of elements or features shown in the drawing. It should be understood that such spatially relative terms are intended to encompass different orientations of the device in use or operation, in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both orientations of above and below.

Before describing an electrode plate according to an embodiment, a rechargeable battery to which the electrode plate may be applied will be described.

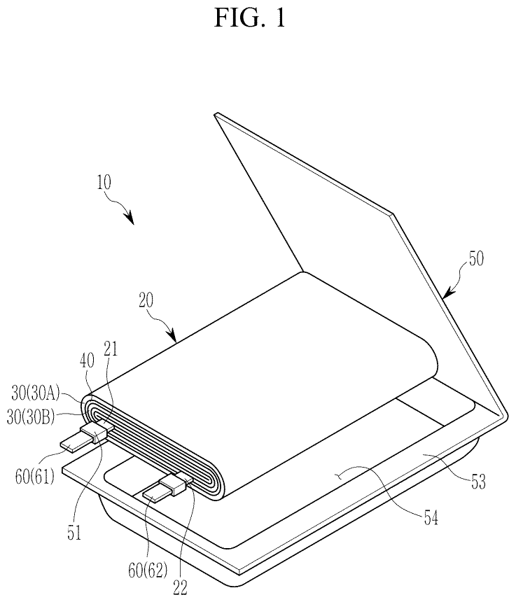

FIG. 1 is an exploded perspective view showing the rechargeable battery, according to an embodiment. Referring to FIG. 1, a rechargeable battery 10 may include an electrode assembly 20, an electrode lead 60, and a case 50.

The electrode assembly 20 may include a plurality of electrode plates 30 and a separator 40. In more detail, the plurality of electrode plates 30 may include a first electrode plate 30A and a second electrode plate 30B.

The electrode assembly 20 may be in the form in which a laminate including the first electrode plate 30A, the second electrode plate 30B, and the separator 40 is wound or repeatedly stacked. For example, the electrode assembly 20 may be a stacked type in which the electrode plates 30A and 30B are disposed to be stacked in a plurality of layers. In another example, the electrode assembly 20 may be a jelly-roll type that is repeatedly wound. In this case, there may be one first electrode plate 30A and one second electrode plate 30B. Such a jelly-roll type electrode assembly 20 may be manufactured by winding a stack in which the first electrode plate 30A, the separator 40, and the second electrode plate 30B are stacked onto two winding beams. In the present disclosure, the electrode assembly 20 of the jelly-roll type will be described as an example.

The separator 40 may be interposed between the first electrode plate 30A and the second electrode plate 30B. The separator 40 prevents short circuiting between the first electrode plate 30A and the second electrode plate 30B, and enables the movement of lithium ions. To this end, the separator 40 may be formed in a size relatively greater than the first electrode plate 30A and the second electrode plate 30B.

The separator 40 may include, for example, a porous polymer film or a porous non-woven fabric. For example, the porous polymer film may be configured in a single layer or multiple layers including a polyolefin polymer such as ethylene polymer, propylene polymer, ethylene/butene copolymer, ethylene/hexene copolymer, and ethylene/methacrylate copolymer. For example, the porous non-woven fabric may include glass fiber of a high melting point, and polyethylene terephthalate fiber. In another example, depending on embodiments, the separator may be a high heat-resistive the separator containing ceramic (e.g., ceramic coated separator (CCS)).

The separator 40 may be installed to be wound along a first direction between the first electrode plate 30A and the second electrode plate 30B. When the electrode plates 30A and 30B are stacked, the separator 40 may be cut into unit lengths and disposed between the first electrode plate 30A and the second electrode plate 30B, or one separator 40 in a ribbon shape may be disposed in a zigzag form between the first electrode plate 30A and the second electrode plate 30B.

Meanwhile, the electrode assembly 20 described above may include electrode tabs 21 and 22. The electrode tabs 21 and 22 may extend from the first electrode plate 30A and the second electrode plate 30B, respectively. The electrode tab extending from the first electrode plate 30A may be a first electrode tab 21, and the electrode tab extending from the second electrode plate 30B may be a second electrode tab 22.

The electrode lead 60 may be connected to the electrode tabs 21 and 22. Two electrode leads 61 and 62 may be provided. One electrode lead 61 may be connected to the first electrode tab 21, and the remaining electrode lead 62 may be connected to the second electrode tab 22. That is, the first electrode plate 30A and the second electrode plate 30B may be electrically connected to the outside of the rechargeable battery 10 through the electrode lead 60.

Meanwhile, a protection member 51 may surround a portion corresponding to the case 50 in the electrode lead 60. The protection member 51 may prevent the electrode lead 60 and the case 50 from being electrically conductive.

The case 50 may accommodate the electrode assembly 20. The electrode assembly 20 described above may be accommodated in the case 50 together with an electrolyte.

Here, the electrolyte may be a non-aqueous electrolyte. The electrolyte may include a lithium salt and an organic solvent. The organic solvent may include one or more of propylene carbonate (PC), ethylene carbonate (EC), diethyl carbonate (DEC), dimethyl carbonate (DMC), ethylmethyl carbonate (EMC), methylpropyl carbonate (MPC), dipropyl carbonate (DPC), vinylene carbonate (VC), dimethyl sulfoxide, acetonitrile, dimethoxyethane, diethoxyethane, sulfolane, gamma-butyrolactone, propylene sulfide, and tetrahydrofuran.

The case 50 may be one of a pouch type, a cylindrical type, and a prismatic type. The case 50 of a pouch type may be manufactured by bending an exterior material of a plate shape, and then pressing or drawing one surface, to have a recess on the one surface.

The electrode assembly 20 may be accommodated in a recess 54. A sealing portion 53 may be provided on an exterior circumference of the recess 54, and while the electrode assembly 20 is accommodated in the recess 54, the sealing portion 53 may be sealing through a method such as heat fusion.

Meanwhile, a plurality of electrode plates 30A and 30B may include a negative electrode plate 30A and a positive electrode plate 30B. The first electrode plate 30A described above may be used as the negative electrode plate, and the second electrode plate 30B may be used as the positive electrode plate, or vice versa.

In addition, the electrode tabs 21 and 22 described above may include a positive electrode tab 22 and a negative electrode tab 21. The negative electrode tab 21 may extend from the negative electrode plate 30A, and the positive electrode tab 22 may extend from the positive electrode plate 30B.

Hereinafter, the electrode plate 30 of the electrode assembly 20 that may be used in the rechargeable battery 10 will be described with reference to the drawings.

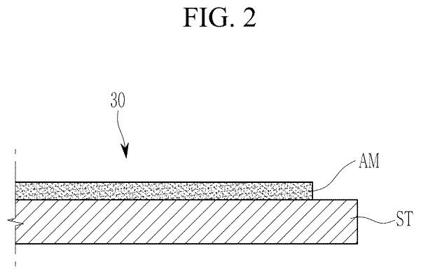

FIG. 2 is a detailed cross-sectional view of the electrode plate 30 included in the rechargeable battery 10 of FIG. 1.

Referring to FIG. 2, in a manufacturing process of the electrode plate 30 included in the electrode assembly 20, an active material layer AM may be generated by applying a slurry on a substrate ST.

The substrate ST may be a current collector, and the current collector may include any suitable conductive material to the extent that it does not cause a chemical reaction within the rechargeable battery. For example, the current collector may include any one of stainless steel, nickel (Ni), aluminum (Al), titanium (Ti), copper (Cu), and an alloy thereof, and may be provided in various forms such as film, sheet, foil, or the like.

The substrate ST may include a current collecting part and an uncoated part. The current collecting part may have at least one surface applied with the active material layer AM. The active material layer AM may be applied to a remaining portion of the substrate ST excluding an edge region of the current collecting part. The edge region of the current collecting part may be the uncoated part where the active material layer AM is not applied.

The active material layer AM may be located on a part of at least one surface of the substrate ST, and may have an end portion formed in multiple stages. An edge of the active material layer AM may be located to be spaced apart from an edge (e.g., an outermost edge) of the substrate ST. A protection film may be attached to a boundary portion between the active material layer AM and the substrate ST.

For example, generating the active material layer AM on the substrate ST may include discharging a slurry on a collector layer by using a slit coater, followed by a magnetizing process using a drying process using a permanent magnet and a heater. The discharging and magnetizing may be sequentially performed.

In another example, generating the active material layer AM on the substrate ST may include attaching an active material layer of a film shape to a collector layer. At this time, the active material layer may be, e.g., a dry active material film. For example, a manufacturing method of the dry active material film may include mixing a binder and an active material, heating (e.g., melting) and stirring it in a twin-screw stirrer, and then extruding it through a nozzle onto the substrate ST.

The present disclosure will refer to the slurry as being coated on the substrate ST by a slit coater to generate the active material layer AM. A typical magnetizing device may magnetize the slurry discharged by a slit coater M. The magnetizing device may apply a magnetic field to the slurry discharged onto the substrate ST to orient it.

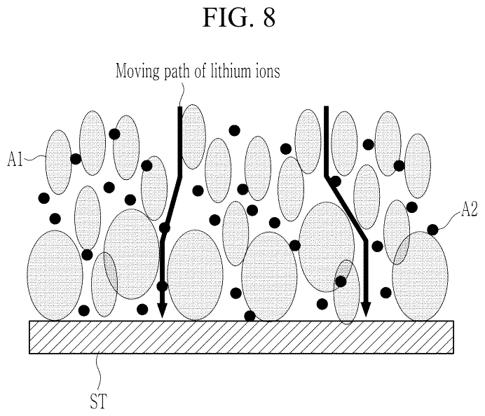

For example, referring to FIG. 8, the active material layer AM may further include graphite particles A1, binders A2, and the conductive material.

The graphite particle A1 may have a diamagnetic anisotropy. For example, the graphite particle A1 may have a plate-like shape. The average particle diameter of the graphite particle A1 may be from 0.05 μm to 30 μm.

The graphite particle A1 may include bulk particles and fine particles. For example, the bulk particles may have an average particle diameter of 1 μm to 30 μm, and the fine particles may have an average particle diameter of 0.05 μm or more and less than 1 μm. When the content of the fine particles is high, reactivity with lithium ions may increase due to the increased surface area.

However, when the content of the fine particles is excessively high, a decomposition or deterioration of the electrolyte may occur due to an increase in the side reactions. According to an embodiment, the weight ratio of the bulk particles and the fine particles may be 10:1 to 3:1.

The binder A2 can mediate bonding between the substrate ST and the active material layer AM, thereby improving mechanical stability. For example, the binder A2 may be an organic binder or an aqueous binder, and may be used together with a thickener such as carboxymethyl cellulose (CMC). More specifically, the organic binder may be one of vinylidene fluoride-hexafluoropropylene copolymer (PVDF-co-HFP), polyvinylidene fluoride (PVDF), polyacrylonitrile, and polymethylmethacrylate, and the aqueous binder may be a styrene-butadiene rubber (SBR).

The conductive material may improve the electrical conductivity of the rechargeable battery. The conductive material may include a metal material. For example, the conductive material may include a carbon conductive material, e.g., at least one of graphite, carbon black, graphene, and carbon nanotube. For example, the conductive material may include carbon nanotube.

Meanwhile, the slurry used for manufacturing the active material layer AM may include not only the graphite particle A1, the binder A2, and the conductive material, described above, but also a solvent. The solvent may be an organic solvent such as N-methylpyrrolidone, dimethyl formamide, acetone, and dimethyl acetamide, water, or a combination thereof. The slurry including such a solvent may include, e.g., 5 wt % to 30 wt % of graphite particles, 1 wt % to 10 wt % of binder, 1 wt % to 10 wt % of conductive material, and 50 wt % to 90 wt % of solvent, based on 100 wt % of the slurry.

Referring back to FIG. 2, the active material layer AM may include a first active material layer, and a second active material layer located on the first active material layer. For example, the first active material layer and the second active material layer may be formed of the same material. In another example, the first active material layer and the second active material layer may be formed of different materials. In addition, the first active material layer may be a material having relatively greater adhesion to the substrate or greater conductivity than the second active material layer.

For example, the first active material layer may include the carbon conductive material. The carbon conductive material included in the first active material layer may be selected from the carbon conductive materials included in the active material layer. The first active material layer may include the carbon conductive material that is the same as the second active material layer. As the first active material layer includes the carbon conductive material, the first active material layer may be, e.g., a conductive layer. The first active material layer may be, e.g., a conductive layer including the binder and the carbon conductive material.

The binder included in the first active material layer may increase the bonding strength between the substrate and the second active material layer. The binder included in the first active material layer may be, e.g., a conductive binder or a non-conductive binder.

The conductive binder may be, e.g., an ion conductive binder, and/or an electron conductive binder. A binder having both of the ion conductivity and the electron conductivity may belong to the ion conductive binder and also to the electron conductive binder.

The ion conductive binder may be, e.g., polystyrene sulfonate (PSS), polyvinylidene fluoride-hexafluoropropylene copolymer (PVDF-HFP, polyvinylidene fluoride-hexafluoropropylene), polyvinyl fluoride (PVF), polyvinylidene fluoride (PVDF), poly(methyl methacrylate) (PMMA), polyethylene oxide (PEO), polyethylene glycol (PEG), polyacrylonitrile (PAN), polytetrafluoroethylene (PTFE), polyethylenedioxythiophene (PEDOT), polypyrrole (PPY), polyacrylonitrile (PAN), polyaniline, polyacetylene, or the like. The ion conductive binder may include a polar functional group. The ion conductive binder including the polar functional group may be, e.g., Nafion, Aquivion, Flemion, Gore, Aciplex, Morgane ADP, sulfonated poly(ether ketone) (SPEEK), sulfonated poly(arylene ether ketone sulfone) (SPAEKKS), sulfonated poly(aryl ether ketone) (SPAEK), poly[bis(benzimidazobenzisoquinolinones) (SPBIBI), poly(styrene sulfonate (PSS), lithium 9,10-diphenylanthracene-2-sulfonate (DPASLi+), or the like.

The electron conductive binder may be, e.g., polyacetylene, polythiophene, polypyrrole, poly(p-phenylene), poly(phenylenevinylene), poly(phenylenesulfide), polyaniline, or the like. The intermediate layer may be a conductive layer that includes, e.g., conductive polymer.

The binder included in the first active material layer may be selected from the binders included in the second active material layer. That is, the first active material layer may include a binder that is the same as the second active material layer. The binder included in the first active material layer may be, e.g., a fluorine binder, and fluorine binder may be, e.g., polyvinylidene fluoride (PVDF).

For example, when the electrode plate 30 is the positive electrode plate 30A, the active material layer including the first active material layer and the second active material layer may include a positive electrode active material. The positive electrode active material may be a material allowing intercalation and deintercalation of lithium (Li) ions.

The positive electrode active material may be a lithium metal oxide. For example, the positive electrode active material may be one of a lithium manganese oxide, a lithium nickel oxide, a lithium cobalt oxide, a lithium nickel manganese oxide, a lithium nickel cobalt manganese oxide, a lithium nickel cobalt aluminum oxide, a lithium iron phosphate compound, a lithium manganese phosphate compound, a lithium cobalt phosphate compound, and a lithium vanadium phosphate compound.

In another example, when the electrode plate 30 is the negative electrode plate 30B, the active material layer may include a negative electrode active material. The negative electrode active material may be a material allowing intercalation and deintercalation of lithium ions. For example, the negative electrode active material may be one of a carbon material such as crystalline carbon, amorphous carbon, carbon composite, and carbon fibers, a lithium alloy, silicon (Si), and tin (Sn). Depending on the embodiment, the negative electrode active material may be natural graphite or artificial graphite, but is not limited to a particular example.

Hereinafter, the electrode plate manufacturing process according to an embodiment that can be used for manufacturing the electrode plate described above will be described with reference to the drawings.

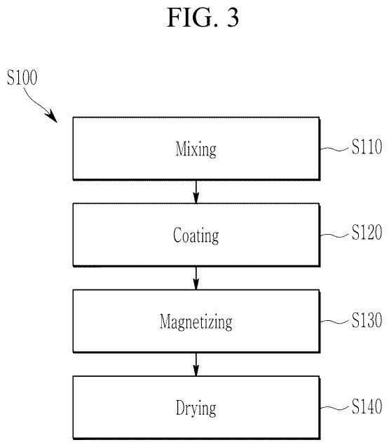

FIG. 3 is a flowchart showing a manufacturing method of an electrode plate according to an embodiment.

Referring to FIG. 3, a manufacturing method S100 of an electrode plate according to an embodiment may include a mixing step S100, a coating step S120, a magnetizing step S130, and a drying step S140.

The mixing step S100 may include mixing a slurry while leaving bubbles in the slurry. A comparative manufacturing method of an electrode plate may completely remove bubbles from the slurry during the slurry mixing process. However, the manufacturing method S100 of an electrode plate according to an embodiment may leave a certain proportion of the bubbles in the slurry during the mixing step S100. The mixing step S100 may generate the slurry by mixing the graphite particles, binder, the conductive material and the solvent.

When the electrode plate manufactured by the manufacturing method S100 of an electrode plate according to an embodiment is a negative electrode plate, a negative electrode solid concentration of the slurry mixed in the mixing step S100 may be included in a range of 50 wt % to 60 wt %. At this time, density of the slurry may be included in a range of 1.1 g/cc to 1.3 g/cc.

When a slurry is completely defoamed in the comparative manufacturing method of an electrode plate (i.e., when all the bubbles are completely removed from the slurry during mixing), the density of the slurry may be 1.4 g/cc based on a negative electrode solid concentration of 53.5 wt % of the slurry. In contrast, according to embodiments (i.e., when a portion of the bubbles remains in the slurry during mixing), based on 53.5 wt % of the slurry mixed in the mixing step, the density of the slurry may be lower than 1.4 g/cc, and the content of bubbles may be estimated approximately from 0.1 g/cc to 0.3 g/cc.

In addition, when the electrode plate manufactured by the manufacturing method S100 of an electrode plate according to an embodiment is the positive electrode plate, the positive electrode solid concentration of the slurry mixed in the mixing step S100 may be included in a range of 70 to 80 wt %. At this time, density of the slurry may be included in a range of 2.0 g/cc to 2.36 g/cc.

Here, when the slurry is completely defoamed in the comparative manufacturing method of an electrode plate (i.e., when all the bubbles are completely removed from the slurry during mixing), the density of the slurry may be 2.46 g/cc based on a negative electrode solid concentration of 76.3 wt % of the slurry. In contrast, according to embodiments (i.e., when a portion of the bubbles remains in the slurry during mixing), based on 76.3 wt % of the slurry mixed in the mixing step, the density of the slurry may be lower than 2.46 g/cc, and the content of bubbles may be estimated to be approximately 0.1 g/cc to 0.46 g/cc.

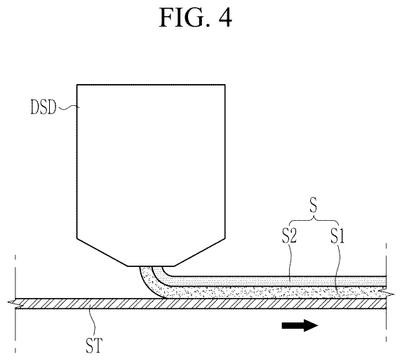

Referring to FIGS. 3 and 4, the coating step S120 may coat the slurry S containing the bubbles on the substrate. Referring to FIG. 4, the coating step S120 may include simultaneously coating a first slurry S1 (used for generating the first active material layer) and a second slurry S2 (used for generating the second active material layer) on the substrate ST, by using a coating device DSD including a first slot and a second slot. At this time, the second slurry S2 may be coated on the first slurry S1 (e.g., the first slurry S1 may be between the substrate ST and the second slurry S2).

In another example, the coating step S120 may include a coating device including a first slot and a second slot, where coating of the first and second slurries is sequential. That is, the coating step S120 may include coating the first slurry used for generating the first active material layer and then coating the second slurry used for generating the second active material layer, on the first slurry.

The coating device for this purpose may be, for example, a dual slot die coater. The dual slot die coater may precisely apply the slurry in a uniform thickness and area. The slurry may be supplied from a slurry storage unit to the dual slot die coater to be stored in the nozzle and then applied by being uniformly spread on the substrate through each of a plurality of slots.

The above description may be include transport by a transporting device. The transporting device for such a purpose may be, e.g., an apparatus configured to transport the substrate in a roll-to-roll manner. A metal foil that can be used as the substrate of the electrode plate of the rechargeable battery may be transported in the first direction, by being in contact with a plurality of rollers.

Referring back to FIG. 3, the magnetizing step S130 may magnetize the slurry coated on the substrate. The magnetizing step S130 may be performed by a magnetizing device. The magnetizing device may magnetize the slurry discharged by the dual slot die coater. The magnetizing device may apply a magnetic field to the slurry applied on the substrate to orient it.

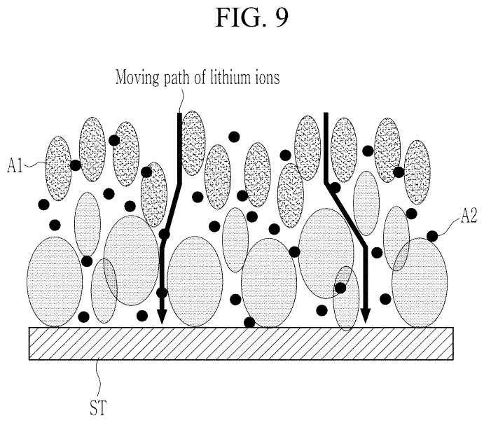

For example, referring to FIG. 9, the graphite particles A1 may be oriented by the magnetizing device to be spaced apart from the substrate ST by a predetermined distance. At this time, the graphite particles A1 may be oriented in a direction orthogonal to the substrate ST by the magnetic field of the magnetizing device.

The magnetizing step S130 is a step of orienting the graphite contained in the negative electrode to a magnetic field in order to improve the charging performance of the negative electrode. More specifically, when manufacturing the negative electrode, a specific crystal plane of the graphite may be oriented in the magnetic field to be substantially parallel to a negative electrode current collector, and the oriented state may be fixed in the drying step S140 to be described later.

Since the edge surface of the graphite layer faces the positive electrode active layer due to the orientation of the graphite, the intercalation and deintercalation of lithium ions are performed smoothly, and at the same time, the electronic conduction path is shortened, thereby improving the electron conductivity of the negative electrode, and thereby improving the charging and discharging performance of the rechargeable battery.

Referring back to FIG. 3, the drying step S140 may generate the active material layer on the substrate by drying the slurry. The drying step S140 may be performed by a drying device. As described above, the magnetized slurry may be dried by the drying device. The solvent included in the slurry may be removed by being gasified (e.g., evaporated) by the drying device. At this time, the graphite particle A1 may be maintained in the state oriented in a particular direction.

The drying device for this purpose may dry the slurry. The drying device may be, e.g., one or more heaters. The heater may be installed to be spaced apart from the substrate. The heater may be located on an upper side or lower side of the substrate based on the direction illustrated in the drawing. The heater may dry the slurry by converting electrical energy into thermal energy. It may be possible to pressurize the slurry at a predetermined pressure by a roller before performing the drying step S140.

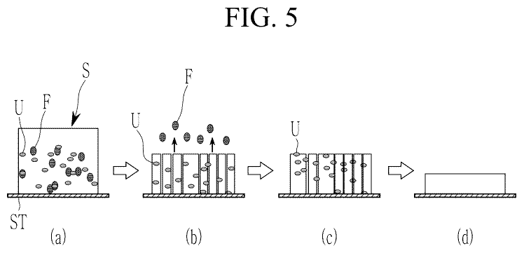

Referring to FIG. 5, the drying step S140 will be described in further detail. Parts (b) to (d) in FIG. 5 are sequential stages in the drying step S140, while part (a) in FIG. 5 illustrates a coated slurry S prior to drying.

Referring to part (a) of FIG. 5, when the slurry S is coated on the substrate ST, moisture U and bubbles F are mixed within the slurry S.

Referring to part (b) of FIG. 5, when the slurry S starts to be dried by the drying device, the bubbles F move to the upper portion of the slurry S and escape to the outside, thereby generating a fine path through the slurry S.

Referring to part (c) of FIG. 5, when drying of the slurry S is proceeded, the moistures U gasified by the heat generated by the drying device may move through the fine path generated by the escaping bubbles F in part (b). As the path is also removed, as seen in part (d) of FIG. 5, the slurry S may be dried and may remain without bubbles or moisture.

Referring back to FIG. 3, the electrode plate manufactured by the manufacturing method S100 according to an embodiment may have a decreased internal resistance, compared to an electrode plate manufactured by a comparative method. The internal resistance of the electrode plate manufactured by the manufacturing method S100 according to an embodiment may have a range of 1.00 mΩ to 1.20 mΩ, e.g., an internal resistance of 1.18 mΩ. The internal resistance and electric characteristic of the electrode plate may be confirmed through the following experiment.

The experiment involved fabricating various electrode plates and measuring not only the internal resistance but also the binder distribution and negative electrode ionic resistance. The electrode plates of Comparative Examples 1 to 3 were electrode plates manufactured by comparative methods for manufacturing electrode plates.

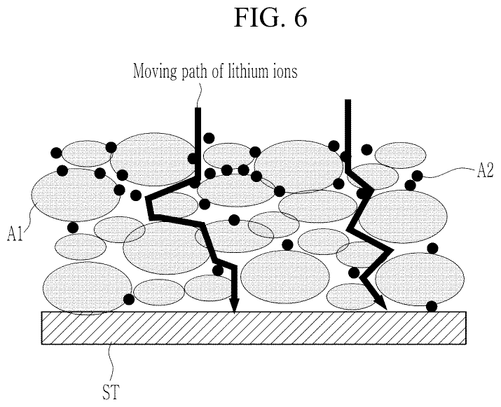

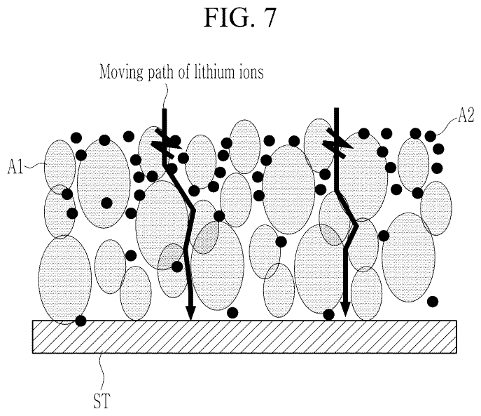

FIG. 6 schematically illustrates a substrate and an active material layer of an electrode plate according to Comparative Example 1, FIG. 7 schematically illustrates a substrate and an active material layer of an electrode plate according to Comparative Example 2, and FIG. 8 schematically illustrates a substrate and an active material layer of an electrode plate according to Comparative Example 3. For better understanding and ease of description, the conductive material is not illustrated in the active material layer.

Referring to FIG. 6, the electrode plate of Comparative Example 1 is an electrode plate manufactured by coating a slurry, from which bubbles are completely defoamed (e.g., removed), on the substrate without performing a magnetizing step. Referring to FIG. 7, the electrode plate of Comparative Example 2 is an electrode plate manufactured by coating a slurry, from which bubbles are completely defoamed (e.g., removed), on the substrate, and additionally performing a magnetizing step compared to Comparative Example 1. Referring to FIG. 8, the electrode plate of Comparative Example 3 is an electrode plate manufactured by coating a slurry, from which bubbles are completely defoamed (e.g., removed), on the substrate in a dual layer method, and additionally performing a magnetizing step.

In addition, referring to FIG. 9, an electrode plate of an Example is an electrode plate manufactured by manufacturing method S100 of an electrode plate according to an embodiment in which a slurry, which includes a predetermined amount of bubbles, is coated on the substrate in a dual layer method as described above, and the magnetizing step S130 is performed.

Referring to FIG. 6, the moving path of lithium ions of the electrode plate of Comparative Example 1 is longer than the lithium ion path of other electrode plates (i.e., compared to FIGS. 7-9). In addition, referring to FIGS. 6-7, the moving path of lithium ions of the electrode plate of Comparative Example 2 is shorter compared to that of the electrode plate of Comparative Example 1. In addition, referring to FIGS. 7-9, the moving path of lithium ions of the electrode plate of Comparative Example 3 and the electrode plate of the Example were further shorter compared to that of the electrode plate of Comparative Example 2.

The above experimental results will be described with reference to Table 1 below. The high binder distribution in Table 1 indicates that the binder is uniformly mixed within the slurry. In addition, the high binder distribution means that a greater proportion of binder is present in a portion (lower portion) in the active material layer in contact with the substrate, compared to a portion (upper portion) far from the substrate. That is, the high binder distribution not only has a beneficial effect on adhesion to the substrate, but also has a beneficial effect on reducing resistance.

The following Table 1 shows values, expressed as a percentage, obtained by measuring the bonding strength of the active material layer on upper and lower portions measure by using the surface and interfacial cutting analysis system (SAICAS), which is an equipment used for analyzing the binder distribution surface and interface, and by dividing them. In addition, the low negative electrode electron resistance indicates being advantageous for the negative electrode electrons to move smoothly.

TABLE 1

| | Comparative | Comparative | Comparative | |
|---|---|---|---|---|
| Categories | Example 1 | Example 2 | Example 3 | Example |
| Binder distribution (%) | 51 | 42 | 69 | 69 |
| Negative electrode electron | 33 | 27 | 15 | 13.5 |
| resistance (Ωm²) | | | | |
| Internal resistance | 1.42 | 1.36 | 1.24 | 1.18 |
| (mΩ) | | | | |

Referring to Table 1, the binder distribution of the electrode plate according to an embodiment was measured to be the same as that of the electrode plate according to Comparative Example 3, and measured to be higher than those of the electrode plate of Comparative Example 1 and the electrode plate of Comparative Example 2.

In addition, as described above, the moving paths of lithium ions of the electrode plate (see FIG. 8) of Comparative Example 3 and the electrode plate (see FIG. 9) of the Example were shown to be similar in the drawing. However, as shown in Table 1, the negative electrode electron resistance and the internal resistance that were actually measured were measured to be further lower in the electrode plate of the Example than in the electrode plate of Comparative Example 3.

Through the above experiment, it may be confirmed that the electrode plate manufactured by the manufacturing method of an electrode plate according to an embodiment has a significantly lower internal resistance than the comparative electrode plate. Accordingly, the output power and life-span of the rechargeable battery may be improved, and as the low temperature is maintained during the charging and discharging process, the operational stability may be improved.

By way of summation and review, the internal resistance of the rechargeable battery represents the resistance generated by the current inside during discharge or charge. The internal resistance is usually determined by various factors such as the electrical conductivity of internal materials of the rechargeable battery, the ion transfer rate within the electrolyte, and the contact resistance between the electrodes and the electrolyte. Since the size of the internal resistance directly affects the performance of the lithium-ion battery, such as output power, lifespan, and temperature characteristics, there is a need to reduce the internal resistance.

The electrode plate manufactured by a manufacturing method of an electrode plate according to the present disclosure shows a significantly low internal resistance compared to a comparable electrode plate. Accordingly, the output power and life-span of the rechargeable battery may be improved, and the low temperature may be maintained during charging and discharging, thereby improving operational stability.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A manufacturing method of an electrode plate, the method comprising:
mixing a slurry while leaving bubbles in the slurry;
coating the slurry containing the bubbles on a substrate;
magnetizing the slurry coated on the substrate; and
generating an active material layer on the substrate by drying the slurry.

2. The method as claimed in claim 1, wherein during the mixing:
a negative electrode solid concentration of the slurry is 50 wt % to 60 wt %, based on 100 wt % of the slurry; and
a density of the slurry is 1.1 g/cc to 1.3 g/cc.

3. The method as claimed in claim 1, wherein during the mixing:
a positive electrode solid concentration of the slurry is 70 wt % to 80 wt %, based on 100 wt % of the slurry; and
a density of the slurry is 2.0 g/cc to 2.36 g/cc.

4. The method as claimed in claim 1, wherein:
the active material layer includes a first active material layer and a second active material layer; and
the coating includes simultaneously coating a first slurry used for generating the first active material layer and a second slurry used for generating the second active material layer on the substrate, via a coating device including a first slot and a second slot.

5. The method as claimed in claim 4, wherein the second slurry is coated on the first slurry.

6. The method as claimed in claim 1, wherein:
the active material layer includes a first active material layer and a second active material layer; and
the coating includes sequentially coating a first slurry used for generating the first active material layer and a second slurry used for generating the second active material layer on the substrate, via a coating device including a first slot and a second slot.

7. The method as claimed in claim 1, wherein the mixing includes generating the slurry by mixing a graphite particle, a binder, a conductive material and a solvent.

8. The method as claimed in claim 1, wherein the active material layer includes a positive electrode active material.

9. The method as claimed in claim 8, wherein the positive electrode active material is one of a lithium manganese oxide, lithium nickel oxide, lithium cobalt oxide, lithium nickel manganese oxide, lithium nickel cobalt manganese oxide, lithium nickel cobalt aluminum oxide, lithium iron phosphate compound, lithium manganese phosphate compound, lithium cobalt phosphate compound, and lithium vanadium phosphate compound.

10. The method as claimed in claim 1, wherein the active material layer includes a negative electrode active material.

11. The method as claimed in claim 10, wherein:
the negative electrode active material is a material allowing intercalation and deintercalation of lithium ions; and
the negative electrode active material includes at least one of carbon material, a lithium alloy, silicon, and tin, and the carbon material including at least one of crystalline carbon, amorphous carbon, carbon composite, and carbon fibers.

12. An electrode plate, manufactured by the manufacturing method as claimed in claim 1.

13. The electrode plate as claimed in claim 12, wherein an internal resistance of the electrode plate is in a range of 1.00 mΩ to 1.20 mΩ.
